(19) United States
(12) Patent Application Publication
(10) Pub. No.: US 2002/0157795 A1
(43) Pub. Date: Oct. 31, 2002

(54) Centrifugal evaporation

(75) Inventor: Duncan Guthrie, Alpheton (GB)

Correspondence Address: Donald F. Frei, Wood, Herron & Evans, L.L.P., 2700 Carew Tower, 441 Vine Street, Cincinnati, OH, 45202-2917, US

(73) Assignee: Genevac Ltd., Ipswich (GB)

(21) Appl. No.: 10/133,622

(22) Filed: Apr. 26, 2002

(30) Foreign Application Priority Data
Apr. 28, 2001 (GB) 0110446.2

(51) Int. Cl. B01D 1/22

(52) U.S. Cl. 159/6.1

(57) ABSTRACT

A centrifugal evaporator is described comprising an enclosure having at least one swinging support rotatable therein and adapted to receive and support at least one microtitre well plate thereon. An infra red radiation source is operated during centrifuging to direct radiation towards the support. A removable shroud is fitted over the well plate and cooperates with the swinging support to form an enclosure which is impervious to direct penetration of radiation from the IR source. The shroud is vented to allow solvent vapour to exit due to evaporation during the heated centrifuging process. The openings in the shroud are baffled to prevent radiation entering the enclosure. The shroud is made up of two parts which fit over the well plate and co-operate with the support and each other to form the radiation free enclosure around the well plate.

### FIELD OF INVENTION

This invention concerns centrifugal evaporators and processes for evaporation primarily for separating volatile components from less volatile components of liquid mixtures, typically volatile solvents in liquid mixtures.

### BACKGROUND TO THE INVENTION

In the preparation of pharmaceuticals and drugs it is a common requirement to separate unwanted volatile solvent components from less volatile materials and one technique which has been developed involves centrifuging the mixture whilst simultaneously evacuating the chamber containing the centrifuged material so as to draw off from the mixture the more volatile component and leave the less volatile material behind. Thus chemists and biologists frequently need to remove liquids in which the solid matter in which they are interested is dissolved or suspended. The solid matter may be potential new drugs, biological samples or other materials. They are frequently sensitive to heat, so that the mixture cannot be boiled off at atmospheric pressure because this would involve excessively high temperatures. Boiling, or evaporation under vacuum is often the preferred process because this can be done at low temperatures which do not harm the samples. If samples in liquids are exposed to vacuum they tend to boil vigorously and this activity can lead to liquid containing valuable sample material being spilled or lost, or worse, to cross-contamination of samples which may have been expensively purified.

It is therefore well known to spin such samples in a closed vacuum chamber so as to subject them to rotation generated centrifugal forces which suppress the spitting or frothing of the liquid while it is boiling under vacuum. This process is known as Centrifugal Evaporation, or Concentration.

If such a Centrifugal Evaporator is to achieve rapid evaporation of solvents it is necessary to heat the samples to provide the energy necessary to sustain evaporation. One well known method of heating is by the use of infra red radiation from lamps located in the wall of the vacuum chamber. Once the solvent within the receptacle is boiling, the rate of evaporation is governed only by the rate of heat input to the solvent.

One known method of operation is to locate the receptacle in which the sample is contained in a holder that will allow infra red radiation from the lamps to heat the solvent in the receptacle directly. This method has the disadvantage that when the solvent in the receptacle is all evaporated, the temperature of the remaining solid compounds cannot be controlled and will increase very rapidly unless the infra red lamps are turned off. Many of the biological compounds that are regularly dried by these evaporators are highly temperature sensitive. A further disadvantage is that the solids while in solution and when dry are subjected to possibly damaging levels of radiation in wavelengths from ultra violet through visible to infra red. With the development of genetic testing using Oligonucleotide Probes it is becoming increasingly common for such probes to contain a “marker”, and these markers are often sensitive to radiation and can therefore be damaged by a broad range of wavelengths including the range from ultra violet through visible to infra red.

An alternative known method aimed at overcoming the problem of temperature control highlighted above is to locate the receptacle in one or more solid aluminium blocks. In this case the block will protect the dried compounds from direct infra red radiation. The radiation from the lamps will heat the block and in turn heat will be transferred to the solvent by conduction between the sample receptacle and the aluminium block. This method gives good temperature control of the samples but has the disadvantage of slow evaporation with some formats of sample receptacle. Receptacles such as Microtitre plates give particularly slow evaporation when conduction is used to transfer the heat required for evaporation into the plate.

One known method of overcoming the damage by UV, visible and infra red radiation is to not use infra red lamps at all. This has the disadvantage of increasing the length of time required for evaporation.

An alternative approach is to use a filter positioned between the IR source and the aperture into the chamber. Such filters are practical in filtering out harmful radiation in the range of wavelengths from 200 nm through to 600 nm but above this figure such filters start to significantly reduce the energy transfer from the source into the evaporation chamber.

It is an object of the present invention to provide means to allow use of infra red lamps to speed the evaporation of the solvent when the samples are contained within microtitre plates, or other similar formats.

### SUMMARY OF THE INVENTION

According to one aspect of the invention there is provided a shroud adapted to fit over a sample holder within a centrifugal evaporator, the shroud being formed from a material which is impervious to UV, visible and IR radiation.

The shroud may be formed for example from a plastics material, or aluminium or stainless steel.

Preferably the shroud is constructed so as also to shield the sample holder from radiation reflected or refracted by surfaces within the evaporation chamber.

When such a shroud is fitted, the liquid sample material may be heated by conduction from a base on which the sample holder is located which is heated by IR radiation from an IR source located so as to direct radiation onto the base during centrifuging, the shroud serving to prevent any of the IR radiation from impinging directly onto the sample holder(s).

Where the centrifugal evaporator includes a swing support for the sample holder(s), the shroud is adapted to fit over the swing support.

Preferably the shroud includes baffled openings to allow solvent vapour to leave the enclosure forward of the shroud and support but to prevent radiation from directly impinging on the sample holder.

Preferably the shroud or support includes a temperature measuring means for sensing the temperature of at least one of the samples.

The shroud may be apertured to provide for the insertion of a temperature sensing probe into the liquid forming one of the samples.

A shroud as aforesaid may be used with one or a stack of microtitre well-plates or with tube or vial sample holders.

In order to improve heat transfer into the liquid samples a heat transfer plate may be provided which is adapted to surround at least a part of each sample containing region of the sample holder and make good contact therewith, to allow for the efficient transfer of heat therebetween.

Where the sample holder is a microtitre well-plate, the transfer plate may be of the type described in our corresponding application filed concurrently herewith under reference C400/G or our corresponding application also filed concurrently herewith, under reference C401/G.

Where the sample holder is adapted to receive and support two or more microtitre well-plates, stacked one above the other, any temperature sensing means is preferably located in a well in the uppermost plate.

The shroud may be a single housing for fitting over and cooperating with the sample holder support to form a radiation free enclosure, or may be formed in two parts which can be fitted from opposite sides of the sample holder support, to cooperate when joined to form a radiation free enclosure therearound.

Where the sample support is adapted to pivot about a longitudinal axis between two jaws, so as to swing through up to 90° during centrifuging, and the support comprises a base and two upstanding ends between which microtitre well-plates are stacked, the shroud is preferably adapted to cooperate with the base and the two upstanding ends to create the enclosure.

The invention also lies in a centrifugal evaporator comprising an enclosure, at least one swinging support rotatable therein and adapted to receive and support at least one microtitre well plate thereon, and an infra red radiation source which is operated during centrifuging to direct radiation towards the support platform characterised by a removable shroud fitted over the well plate and cooperating with the swinging support to form an enclosure which is impervious to direct penetration of radiation from the said source, but is vented to allow solvent vapour to exit due to evaporation thereof during the heated centrifuging process.

The invention will now be described by way of example with reference to the accompanying drawings, in which:

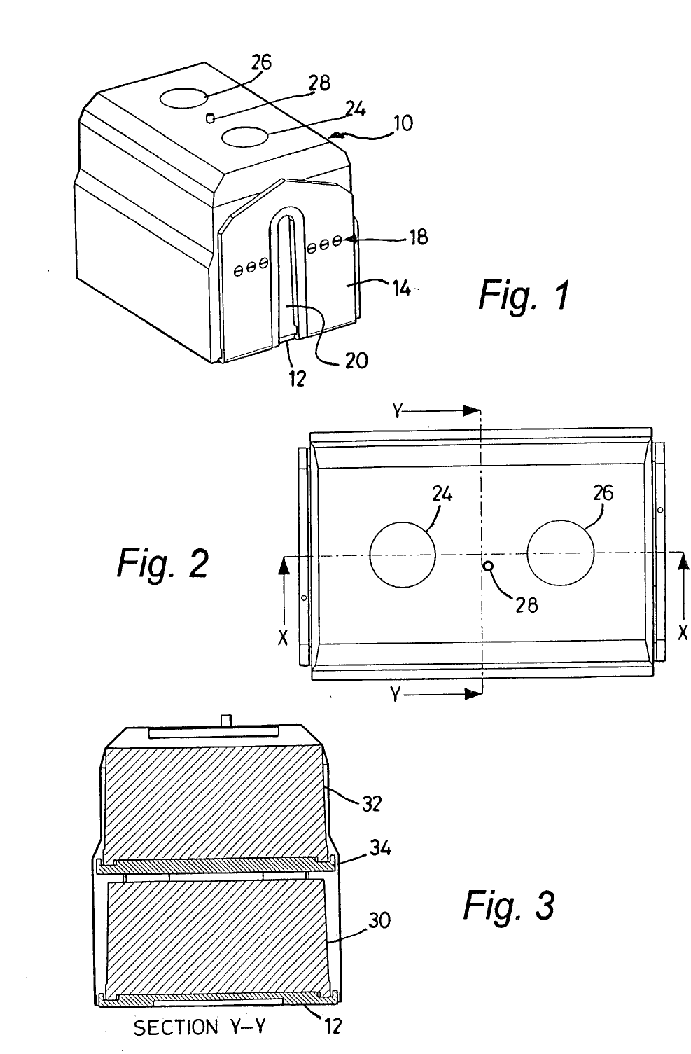

FIG. 1 is a general perspective view of a two-tier swinging sample holder support for a centrifugal evaporator loaded with two microtitre well-plates, with a shroud for protecting the samples from direct radiation,

FIG. 2 is a top plan view of the shroud of FIG. 1,

FIG. 3 is a cross section on YY in FIG. 2,

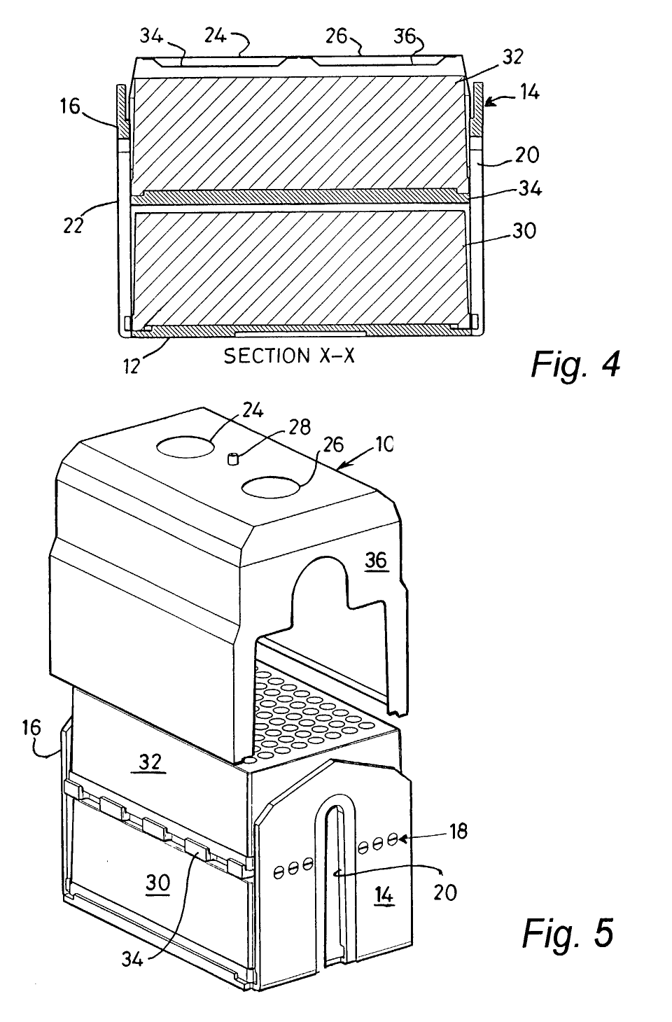

FIG. 4 is a cross section on XX in FIG. 2, and

FIG. 5 is an exploded perspective view of the shroud and support of FIG. 1, showing the microtitre well plates stacked in the carrier.

### DETAILED DESCRIPTION OF THE DRAWINGS

FIG. 1 shows the enclosed sample holder formed by fitting a shroud 10 (having an inverted-U configuration) over a stack of two microtitre well plates (not shown in FIG. 1) carried on a base 12 between opposite upstanding ends thereof, one of which is shown at 14 in FIG. 1, the other 16 being visible in other Figures. A shelf for supporting the upper plate above the lower one in the stack, is secured between the two ends by screws—one line of which is shown at 18, the line of screws at the opposite end not being visible.

Each end 14, 16 includes a slot, the slot in end 14 being denoted by reference numeral 20 and the other at the opposite end being denoted by 22.

The lower end of each of slots 20, 22 is open to allow the device to be fitted over and lowered between a pair of aligned and suitably spaced apart pins, (not shown) on which the device can pivot, and to this end the upper region of each slot is bridged to form a closed upper end, the internal configuration of which is semi-cylindrical and has a radius of curvature similar to that of the pins, so as to permit the device to swing about the pins.

Two openings 24, 26 in the roof of the shroud 10 allow solvent vapour to exit the enclosure, but in order to prevent entry of radiation into the enclosure, each opening has a solid plate aligned with it on the inside (or externally if preferred, albeit not shown), and spaced from the opening by a small distance to allow vapour to exit around the plate, but to prevent the direct ingress of radiation.

A third opening (not shown) is provided through which a temperature probe can be lowered, with an end region of the probe, denoted by 28, protruding above the roof 10. A radio link may be used to convey temperature information to a remote stationary receiver-decoder and temperature display means (not shown), or a cable connection with slip rings or other connection allowing relative rotation to occur, is provided to a decoder and temperature display means.

The two openings 24, 26 and the temperature probe 28 are clearly visible in the plan view of FIG. 2. The two well plate housings 30, 32 are visible in FIGS. 3 and 4, as is the shelf 34 on which housing 32 is located, above housing 30.

The slot 22 is also visible in FIG. 4 as are the spaced baffle plates 34, 36 below the openings 24, 26.

The exploded perspective view of FIG. 5 shows how the inverted U-shaped shroud 10 can slide over and down the stack of two well plates 30, 32 so that the lower edges of the two opposite sides of the shroud can engage the opposite side edges of the base, one of which is shown at 34.

Each end of the shroud 10 is cut away to define an arched opening, to allow for the end of the pins engaged in the slots 20, 22 to protrude through and beyond the thickness of the end walls of the carrier. As will be seen by comparing FIG. 5 with FIG. 1, the end walls of the shroud (one of which is denoted by reference numeral 36 in FIG. 5) fit between the stack of microtitre well plate housings and the upstanding ends 14, 16 of the carrier, and when fitted to the latter, the shroud prevents radiation from directly entering the enclosure so formed.

Heat is conducted to the upper plate by conduction through the upstanding ends 14, 16 which together with the base 12 therefore need to be formed from a material having good thermal conductivity, such as aluminium. In addition the cross-sections of the base, ends, and the intermediate shelf 34, are selected to ensure minimal temperature gradient in these parts of the carrier. Likewise the screws 18 are preferably formed from a material having good thermal conductivity to assist heat transfer across the junctions between the ends of the shelf 34 and the carrier ends 14, 16.

Conveniently the microtitre plates are formed from moulded plastic material and at least the base if not also the walls of each well and the surrounding plate material is tranlucent if not transparent.

I claim:

1. A shroud adapted to fit over a sample holder within a centrifugal evaporator, the shroud being formed from a material which is impervious to UV, and/or visible and/or IR radiation.

2. A shroud according to claim 1 which is formed from a plastics material, or aluminium or stainless steel.

3. A shroud according to claim 1 characterised in that it is formed in two parts which are adapted to fit from opposite sides of the sample holder to form a radiation free enclosure therearound.

4. A centrifugal evaporator when fitted with a shroud according to claim 1, comprising a rotatable sample support in a chamber, the support having a base on adapted to receive least one sample holder containing liquid sample material, an IR source located so as to direct radiation onto the base during centrifuging to heat the base and thereby heat liquid sample material in the holder by conduction from the base, and wherein the shroud is fitted to the support and serves to prevent any of the IR radiation from impinging directly onto the sample holder.

5. A centrifugal evaporator according to claim 4 which includes a swing support for the sample holder, and the shroud is adapted to fit over the swing support.

6. A centrifugal evaporator according to claim 5 characterised in that the shroud includes baffled openings to allow solvent vapour to leave the enclosure formed by the shroud and the support, the baffles serving to prevent radiation from directly impinging on the sample holder.

7. A centrifugal evaporator according to claim 4, characterised by a temperature measuring means for sensing the temperature of at least one of the samples.

8. A centrifugal evaporator according to claim 7 wherein the temperature sensing means is in the shroud.

9. A centrifugal evaporator according to claim 7 wherein the temperature sensing means is in the support.

10. A centrifugal evaporator according to claim 7 characterised in that the shroud is apertured and the temperature sensing means is a probe and the probe is adapted for insertion into and through the aperture in the shroud.

11. A centrifugal evaporator according to claim 4 wherein the sample holder comprises at least one microtitre well-plate or tube or vial.

12. A centrifugal evaporator according to claim 11 wherein there are at least two microtitre well-plates, stacked one above the other on the support, and temperature sensing means is located in a well in the uppermost plate.

13. A centrifugal evaporator according to claim 4 characterised in that a heat transfer plate is provided which is adapted to surround at least a part of a region of the sample holder containing liquid sample material and make to good contact therewith, to allow for the efficient transfer of heat therebetween.

14. A centrifugal evaporator according to claim 4 wherein the shroud is a single housing which fits over and co-operates with the sample holder support to form a radiation free enclosure.

15. A centrifugal evaporator according to claim 4 wherein the shroud is formed in two parts which are fitted from opposite sides of the support, to co-operate therewith when joined to form a radiation free enclosure therearound.

16. A centrifugal evaporator according to claim 4 comprising two jaws between which the sample support pivots about a longitudinal axis, thereby to enable it to swing through up to 90° during centrifuging, the support comprises a base and two upstanding ends between which microtitre well-plates are stacked, and the shroud co-operates with the base and the two upstanding ends to create a radiation free enclosure.

17. A centrifugal evaporator according to claim 4 wherein the shroud is constructed so as also to shield the sample holder from radiation reflected or refracted by surfaces within the evaporation chamber.

18. A centrifugal evaporator comprising a chamber, at least one swinging support rotatable therein and adapted to receive and support at least one microtitre well plate thereon, and an infra red radiation source which is operated during centrifuging to direct radiation towards the support characterised by a removable shroud fitted over the well plate and co-operating with the swinging support to form an enclosure which is impervious to direct penetration of radiation from the said source, but is vented to allow solvent vapour to exit due to evaporation during the heated centrifuging process.
